(19) United States
(12) Patent Application Publication
(10) Pub. No.: US 2006/0113328 A1
(43) Pub. Date: Jun. 1, 2006

(54) System for controlled release of cement mixture from a suspended bucket

(76) Inventor: Eitan Leibovitz, Even Yehuda (IL)

Correspondence Address: VARNUM, RIDDERING, SCHMIDT & HOWLETT LLP, 333 BRIDGE STREET, NW, P.O. BOX 352, GRAND RAPIDS, MI, 49501-0352, US

(21) Appl. No.: 10/541,833

(22) PCT Filed: Jan. 12, 2004
(86) PCT No.: PCT/IL04/00027

§ 371 Date: Jul. 12, 2005

(30) Foreign Application Priority Data
Jan. 13, 2003 (US) 60439425

(51) Int. Cl. B67D 5/06

(52) U.S. Cl. 222/181.1

(57) ABSTRACT

A suspended concrete bucket for dispensing concrete in building sites. A shutter is disposed at the at the cement releasing aperture of the bucket. The shutter is horizontally slidable, controlled by a handle. Opening of the aperture is controlled by an operator sliding the shutter on wheels. The released cement flows through the opened aperture into a hose, for pouring into forms.

### TECHNICAL FIELD OF THE INVENTION

The present invention relates to handling and utilization of cement buckets suspended from cranes.

### BACKGROUND OF THE INVENTION

Concrete buckets suspended from cranes are used to distribute flowable concrete into pre-formed forms of a building project. Several operators are needed to direct the bucket to a convenient position above the form, to release the concrete from the bucket and to distribute discharged concrete. Pouring concrete efficiently and safely from suspended concrete buckets is a crucial task in a building project.

### BRIEF DESCRIPTION OF THE DRAWINGS

FIG. 1 is a schematic description of the bucket of the invention with the shutter partially closed;

FIG. 2 is a schematic description of the bucket of the invention with the shutter closed;

FIG. 3 is a schematic description of the shutter and suspending wheels;

FIG. 4 is a schematic description of the shutter and suspending wheels in an opened condition.

### DETAILED DESCRIPTION OF THE PRESENT INVENTION

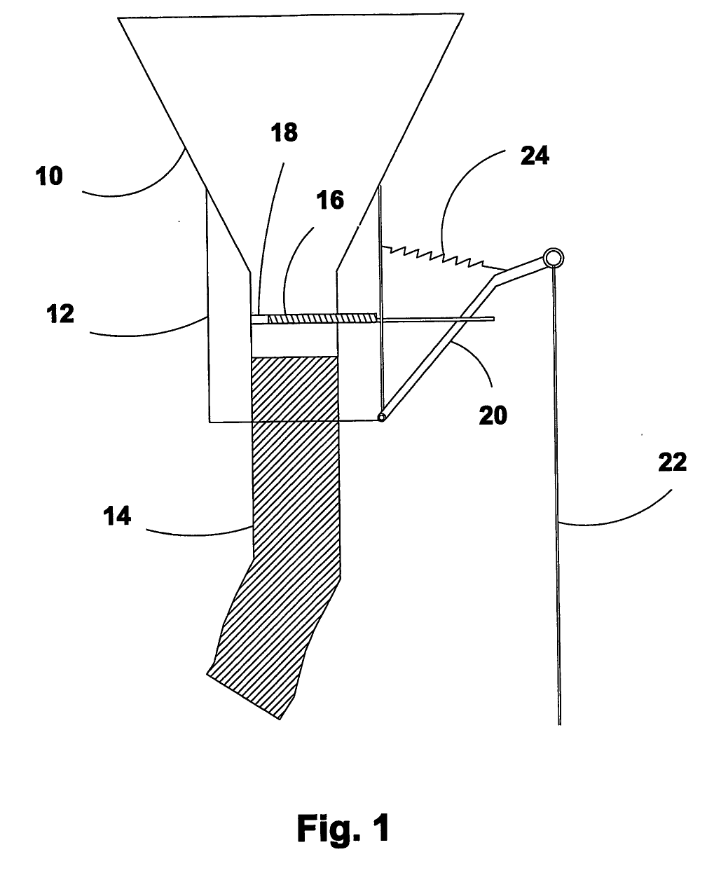

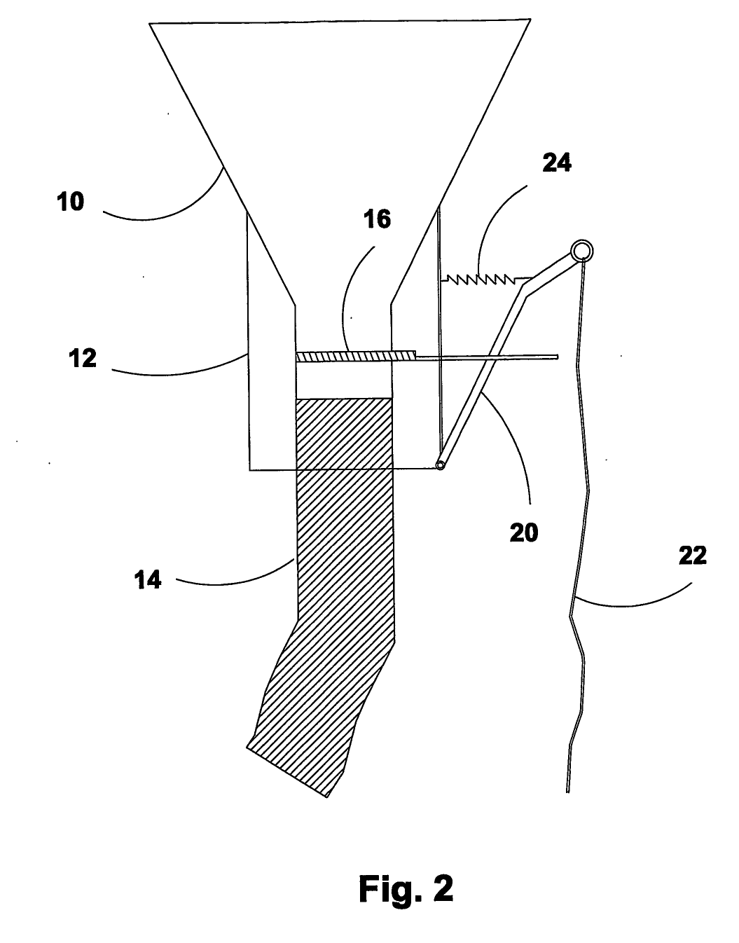

In accordance with the present invention, cement is released gravitationally from a suspended cement bucket by the opening of a shutter at the bottom of the bucket. Opening of the bucket outlet aperture is performed by an operator pulling a rope, the length of which is not limited. To explain the mechanism of the release of cement, reference is made now to FIG. 1. To bucket 10 is appended a construction frame 12. A hose 14 at the bottom of the bucket 10 receives the concrete when shutter 16 is opened. In the figure the aperture 18 is partially opened. Handle 20 is pulled by an operator (not shown) through manipulation of the rope 22. Spring 24 biases the handle 20 and the shutter 16 towards the bucket 10. A second operator manipulates the flexible hose 14, when the shutter is opened, for distributing the flowing concrete. This can however be done by the same operator opening the shutter. In FIG. 2 the handle 20 has been released by the operator, by loosening the rope 22. The spring 24 has contracted, shutting off the shutter 16. Concrete can no longer flow out of the bucket 10.

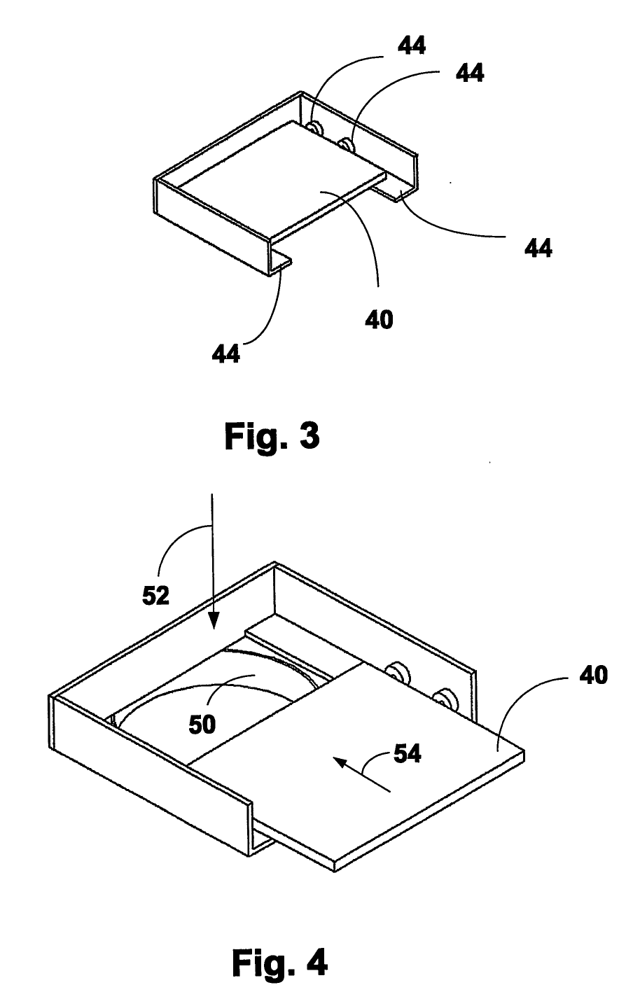

The main structural features of a shutter of the invention are shown in FIG. 3. Shutter 40 is slidable by wheels 42 attached at its both flanks (only the wheels at one flank are shown). The wheels roll on rails 44. In FIG. 4 the shutter is shown opened, revealing hose flange 50 of the hose described above. At this state, concrete pouring down from the concrete bucket in the direction of arrow 52 can flow downwards through the hose. The shutter 40 closes by pushing in the direction of arrow 54.

1. A suspended concrete bucket comprising a bottom shutter for releasing flowable concrete gravitationally, and wherein said shutter is slid by an operator.

2. A suspended concrete bucket comprising a bottom shutter for releasing flowable as in claim 1 and wherein said operator uses a handle to slide said shutter, and wherein said shutter is biased towards a closed position by a spring.

3. A suspended concrete bucket comprising a bottom shutter for releasing flowable as in claim 1 and wherein said shutter slides on wheels.
